(19) United States
(12) Patent Application Publication
(10) Pub. No.: US 2022/0057038 A1
(43) Pub. Date: Feb. 24, 2022

(54) APPARATUS AND METHOD FOR EVERTING A LINING MATERIAL

(71) Applicant: SHONAN GOSEI-JUSHI SEISAKUSHO K.K., Hiratsuka-shi (JP)

(72) Inventor: Michihito TAKASHIMA, Chiba (JP)

(21) Appl. No.: 17/299,297

(22) PCT Filed: Nov. 11, 2019
(86) PCT No.: PCT/JP2019/044189

§ 371 Date: Jun. 2, 2021

(30) Foreign Application Priority Data
Dec. 4, 2018 (JP) 2018-227589

(51) Int. Cl. F16L 55/165

(52) U.S. Cl. CPC F16L 55/1651

(57) ABSTRACT

An eversion container 1 includes an opening section 2 having an opening 30 formed into which a lining material 60 is inserted and through which it can passes; and an eversion nozzle 12 to which one end of the lining material is airtightly attached. The eversion container is filled with an incompressible liquid 40 up to a predetermined level 40a beyond the opening of the opening section to form an airtightly sealed space above the liquid. Compressed gas is supplied to the airtightly sealed space to evert the lining material. A liquid supply pump 50 supplies the liquid in a liquid tack into the eversion container in compensation for the liquid flowing out of the opening section under the action of the compressed gas so that the liquid is kept at the predetermined level. The compressed gas can continuously evert the lining material without leaking through the opening section.

### TECHNICAL FIELD

The present invention relates to an apparatus and a method in which a tubular lining material is folded back at one end and airtightly attached to an eversion nozzle and an eversion pressure is applied thereto to evert the lining material.

### BACKGROUND ART

Conventionally, when an existing pipe such as a sewer pipe buried underground has deteriorated, the inner wall surface of the existing pipe is lined to rehabilitate the existing pipe using a lining material having a resin absorbent material that is made of a flexible tubular non-woven fabric and impregnated with a setting resin.

The lining material is everted and inserted into the existing pipe or pulled in for insertion. In a case where the lining material is everted for insertion into the existing pipe, an apparatus for everting the lining material, is used. Patent Document 1 below describes an arrangement in which the lining material is wound into a roll and housed in a sealed housing container with one end thereof folded back for attachment to an eversion nozzle and compressed air is supplied to the housing container to evert the lining material.

Patent Document 2 below describes an arrangement in which the lining material is folded back at one end for attachment to one end of an eversion tube and passed at the other end through a sealed opening attached to the other end of the eversion tube, and compressed air is supplied into the tube to evert the lining material.

Patent Document 3 below describes an arrangement in which a lining material is drawn a certain length into a chamber provided with an eversion nozzle as well as an inlet and an outlet for the lining material, and the inlet is thereafter closed with the outlet made open to introduce compressed air into the chamber and evert the lining material. In this arrangement, after the lining material is everted and inserted a certain length into the existing pipe, the outlet is closed with the inlet made open and the lining material is newly drawn a certain length into the chamber. Repeating the operation as described above allows the lining material to be continuously everted and inserted into the existing pipe.

### PRIOR ART DOCUMENTS

### Patent Documents

Patent Document 1: JP 2006-205722 A

Patent Document 2: U.S. Pat. No. 6,390,795

Patent Document 3: JP 2012-516251 A

### SUMMARY OF INVENTION

### Problems to be Solved

The arrangement of Patent Document 1 has a drawback that the length of the lining material that can be inverted is limited because only the lining material stored in the housing container can be inverted. If it is desired to evert a long lining material, there is a problem that it is necessary to increase the volume of the housing container according to the length thereof.

On the other hand, in the arrangement described in Patent Document 2, the length of the lining material is not limited and the lining material can be inverted. However, in the arrangement of Patent Document 2, compressed air that everts the lining material leaks from the sealed opening. This deteriorates the eversion efficiency. If the opening is more strongly sealed to prevent the leakage, it becomes difficult for the lining material to pass through the sealed opening, so that it is necessary to increase the air pressure. However, if the air pressure is increased, there is a problem that leakage from the sealed opening further progresses with the result that the eversion efficiency deteriorates and noise due to leakage of compressed air becomes remarkable.

On the other hand, also in the arrangement of Patent Document 3, the lining material can be everted without the length limitation by alternately repeating the drawing and everting of the lining material. However, in the arrangement of Patent Document 3, a mechanism for drawing the lining material of only a certain length is required, and the inlet and the outlet for the lining material must be alternately opened or closed in synchronization with the alternating operation of drawing and everting the lining material. This causes a problem that the mechanical burden and the energy loss are increased.

The present invention has been made to solve such problems and has an object to provide an everting apparatus and a method in which it is possible to reduce the eversion space for a lining material and the lining material can be continuously everted without the leakage of compressed gas that everts the lining material and without the length limitation of the lining material.

### Means for Solving the Problems

The present invention (claim 1) provides an apparatus in which a tubular lining material is airtightly attached at one end to an eversion nozzle and eversion pressure is applied to the eversion nozzle to evert the lining material, comprising:

an opening section having an opening through which the lining material can pass in contact therewith;

an eversion container having an eversion nozzle to which the one end of the lining material is airtightly attached, the container being filled with an incompressible liquid up to a predetermined level beyond the opening to form an airtightly sealed space above the liquid;

a compressed gas source that supplies compressed gas to the airtightly sealed space to evert and discharge the lining material attached to the eversion nozzle to the outside of the eversion container;

a liquid tank that stores the liquid with which the eversion container is filled; and

a liquid supply device that supplies the liquid to the eversion container in compensation for the liquid flowing out of the eversion container under the action of the compressed gas through a gap between the opening and the lining material so that the liquid in the eversion container is kept at the predetermined level.

The present invention (claim 10) provides a method for everting a lining material using an apparatus as described above, comprising:

guiding the lining material from the opening section to the eversion nozzle and airtightly attaching one end of the lining material to the eversion nozzle;

filling the eversion container with an incompressible liquid up to a predetermined level beyond the opening of the opening section to form an airtightly sealed space above the liquid;

supplying the compressed gas to the airtightly sealed space to evert and discharge the lining material attached to the eversion nozzle to the outside of the eversion container; and
supplying the liquid to the eversion container in compensation for the liquid flowing out of the eversion apparatus through the opening under the action of the compressed gas so that the liquid in the eversion container is kept at the predetermined level.

### Effect of the Invention

In the present invention, the eversion container is filled with a predetermined level of incompressible liquid and has at the upper part thereof an airtightly sealed space for everting the lining material. Even if the compressed gas is supplied to the airtightly sealed space to evert the lining material and the liquid flows out of the eversion container under the action of the compressed gas, the liquid is supplemented to the eversion container and it is always filled with a predetermined level of liquid. Therefore, the compressed gas supplied to the airtightly sealed space can be continuously used to evert the lining material without leakage. This allows the lining material to be continuously everted regardless of the length of the lining material. Furthermore, the eversion container only needs to house the lining material from the opening into which the lining material is inserted to the eversion nozzle, so that its volume can be significantly reduced.

### BRIEF DESCRIPTION OF DRAWINGS

FIG. 1 is a perspective view showing the appearance of an apparatus for everting a lining material;

FIG. 2 is a cross-sectional perspective view of an eversion container along the line A-A of FIG. 1;

FIG. 3 is a side view of the eversion container;

FIG. 4 is a front view of the eversion container;

FIG. 5 is a rear view of the eversion container;

FIG. 6 is an illustrative view showing a state in which the lining material is everted and inserted into the existing pipe;

FIG. 7a is a front view of an opening member;

FIG. 7b is a cross-sectional view of the opening member along the line B-B of FIG. 7a;

FIG. 8a is a perspective view of a lining material;

FIG. 8b is a cross-sectional view of the lining material that is folded flat and viewed along the line C-C of FIG. 8a;

FIG. 8c is an illustrative view showing a state in which a hot water hose is connected to the end of the lining material;

FIG. 9 is an illustrative view showing a state in which the liquid in the eversion container is maintained at a predetermined level;

FIG. 10 is a perspective view of an eversion container provided with first and second opening sections;

FIG. 11 is a cross-sectional view of the eversion container along the line D-D of FIG. 10;

FIG. 12 is a cross-sectional view of the first opening section along the line E-E of FIG. 11;

FIG. 13 is a cross-sectional view of the first opening section showing a state in which an opening is enlarged;

FIG. 14a is a front view showing an opening member of the first opening section;

FIG. 14b is a cross-sectional view showing the opening member of the first opening section along the line G-G of FIG. 14a;

FIG. 15 is a cross-sectional view of the second opening section along the line F-F of FIG. 11;

FIG. 16 is a cross-sectional view of the second opening section showing a state in which an opening is enlarged;

FIG. 17a is a front view showing an opening member of the second opening section;

FIG. 17b is a cross-sectional view showing the opening member of the second opening section along the line H-H of FIG. 17a;

FIG. 18 is an illustrative view showing a state in which a lining material, a connecting tool, and a hot water hose pass through the first and second opening sections;

FIG. 19 is an illustrative view showing a state in which a lining material, a connecting tool, and a hot water hose pass through the first and second opening sections;

FIG. 20 is an illustrative view showing a state in which the liquid is poured until it flows into the eversion nozzle;

FIG. 21 is an illustrative view showing a state in which the lining material is everted by air pressure and hydraulic pressure for insertion into the existing pipe;

FIG. 22 is a perspective view showing another embodiment of the eversion container; and

FIG. 23 is an illustrative view showing a state in which the lining material is everted using the eversion container in FIG. 22.

### MODE OF CARRYING OUT THE INVENTION

Hereinafter, embodiments of the present invention will be described with reference to the accompanying drawings. The present invention is used to evert a lining material for repairing an existing pipe buried underground such as an aged sewage pipe, but it is also applicable for an example in which a lining material for repairing other pipelines is everted.

### Embodiment 1

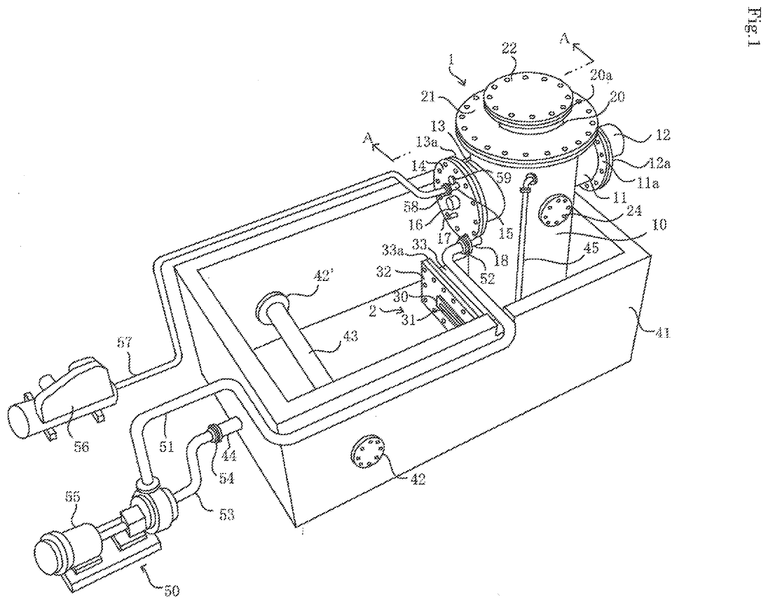

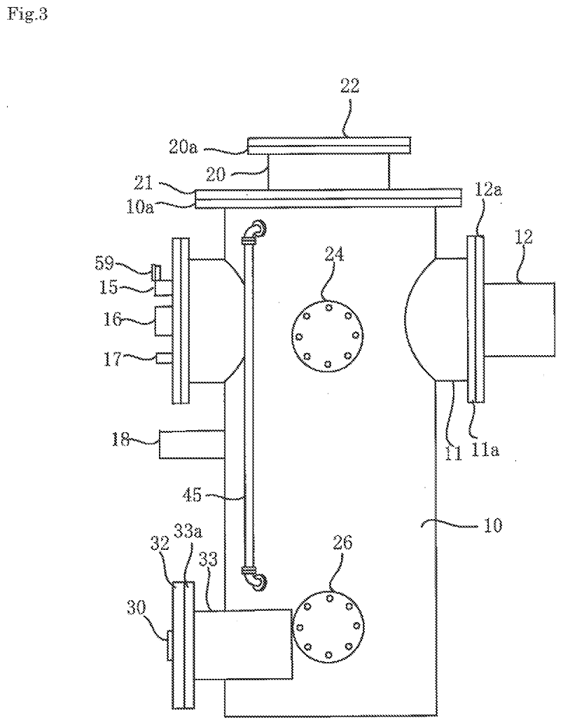

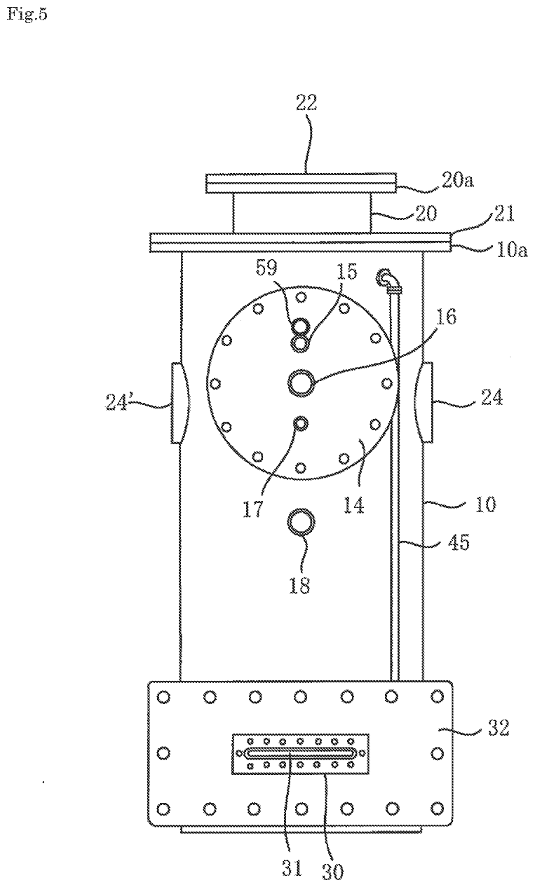

FIGS. 1 through 6 show an apparatus for everting a lining material that is provided with an eversion container 1 for everting a lining material. The eversion container 1 is a metal pressure-resistant container and includes a hollow cylindrical portion 10. An eversion nozzle 12 is attached to the upper part of the eversion container 1 through a side pipe 11. The eversion nozzle 12 is attached by airtightly connecting the flange 12a of the eversion nozzle 12 and the flange 11a of the side pipe 11 using fixing means including a plurality of bolts and nuts (both not shown). In each figure, a small circle drawn on a flange or a disk indicates a hole through which a bolt is passed.

Hereinafter, connecting and fixing two members in an airtight manner by fixing means of bolts and nuts is called bolting or bolt tightening. A packing member may be interposed to ensure an airtight connection. Since the two bolted members are separated by removing the bolts and nuts, it also means that the two members are detachably and airtightly connected.

On the side of the eversion container 1 opposite the side pipe 11, a side pipe 13 extends in the direction opposite the side pipe 11 and a disk 14 is bolted to the flange 13a. The disk 14 is provided with a gas supply port 15 for supplying gas supplied from a later described compressed gas source, a hot water supply port 16 for supplying hot water for curing the lining material after completion of the eversion work, and a hot water drain port 17 for draining hot water. Below the side pipe 13, a liquid supply port 18 is further attached that supplies to the eversion container 1 an incompressible liquid, which will be described later.

A disk-shaped cover 21 provided with a mount tube 20 is bolted to the flange 10a of the cylindrical portion 10 on the upper portion of the eversion container 1, and a disk 22 is bolted to the flange 20a of the mount tube 20.

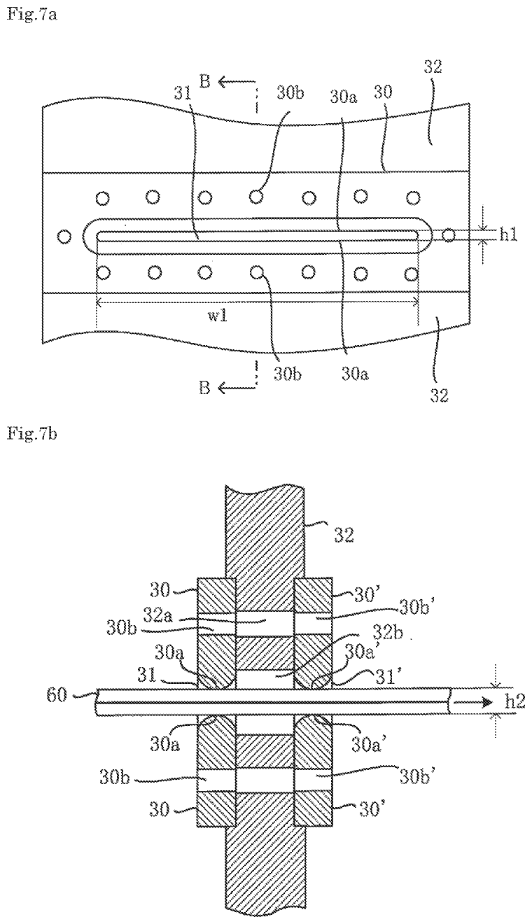

The eversion container 1 is provided at the lower part with an opening section 2 having an opening into which a lining material can be inserted and through which the lining material passes in contact therewith. The opening section 2 has, for example, an opening member 30 made of MC nylon having good slippage or a metal (for example, stainless steel) polished to have good slippage. As shown in FIGS. 7a and 7b, the opening member 30 has a slit-shaped opening 31 that extends in the horizontal direction and has a width w1 and a height h1 corresponding to the cross-sectional shape of a flattened lining material 60.

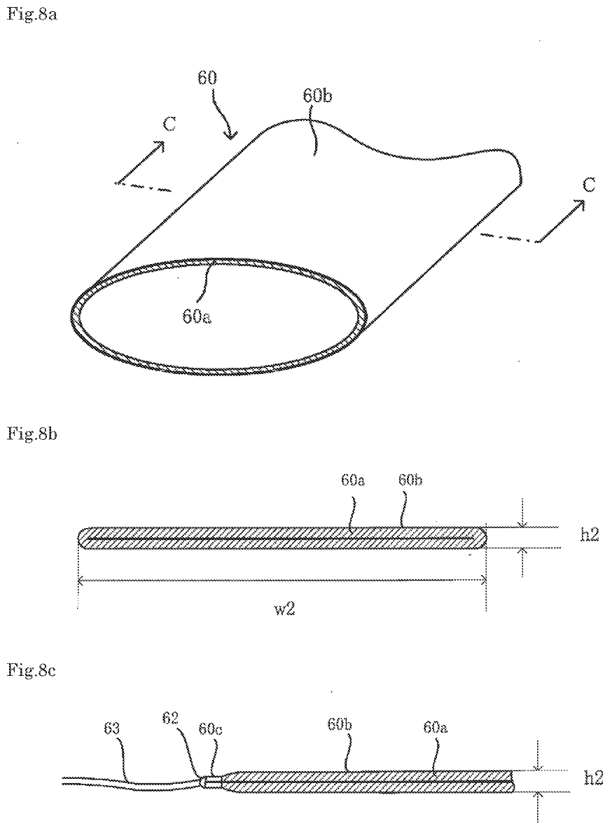

As shown in FIGS. 8a and 8b, the lining material 60 has a resin absorbent material 60a that is made of a tubular flexible nonwoven fabric and impregnated with a curable resin with the outer surface thereof coated with an airtight plastic film 60b. A plastic fiber, a glass fiber, or the like is used as the non-woven fabric material. The curable resin includes a thermosetting resin such as an unsaturated polyester resin or an epoxy resin, or a photocurable resin, or a resin mixed with the thermosetting resin and the photocurable resin. The resin absorbent material 60a may be formed in multiple layers instead of a single layer.

The lining material 60 has, when flattened, the width w2 and the height h2, as shown in FIG. 8b. The width w1 of the opening 31 is set to be about the same as or slightly larger than w2 and the height h1 of the opening 31 is set to be about the same as or slightly larger than h2 so that the lining material 60 can pass through the opening 31 in contact therewith.

As shown in FIG. 8c, the end of the lining material 60 forms an airtightly sealed portion 60c. Since the sealed portion 60c of the lining material 60 is not impregnated with the resin, the thickness of the sealed portion 60c is smaller than h2. An accessory having a diameter smaller than h2 is further attached to the sealed portion 60c using a connecting tool 62 having a thickness smaller than h2. The small-diameter accessory connected to the end of the lining material 20 includes a hose that supplies a heat medium for curing the thermosetting resin when the lining material 20 is impregnated with the thermosetting resin. Therefore, the accessory is referred to as a hot water hose in the following. A hot water hose 63 has a large number of ejection holes and is guided into the existing pipe as the lining material 60 is everted, and the hot water shower ejected from the ejection holes causes the thermosetting resin of the lining material 60 in the existing pipe to be cured.

In order to allow the lining material 60 to smoothly move through the opening 31 that horizontally extends in a slit shape, the vertical upper and lower ends of the opening 31 as viewed in the thickness direction of the passing lining material are, as shown in FIG. 7b, curved to provide curved portions 30a formed in an arc shape in the direction of the lining material so that the lining material 60 passes in line contact with the upper and lower ends thereof. The lining material 60 passes through the opening 31 with its outer circumference in line contact with the curved portions 30a at the upper and lower ends thereof, so that the contact area between the lining material 60 and the opening 31 is made small. As a result, the lining material 60 can smoothly pass through the opening 31.

The opening 31 is designed in a shape corresponding to the cross-sectional shape of the lining material so that the lining material 60 can pass therethrough and in a shape so as to come into contact with the outer surface (outer peripheral surface) of the lining material when the lining material passes therethrough. An unavoidable gap is created between the opening 31 and the lining material 60 passing there through. The eversion container 1 is, as described later, filled with an incompressible liquid, so that, when a high pressure is applied to the liquid, it flows out of the eversion container 1 through this gap or a portion that is not sufficiently in contact. In order to prevent this outflow and improve the liquid sealing property, the opening 31 is shaped so that the flow path area of the liquid that flows through the gap is made as small as possible, that is, the flow path resistance is made large. The opening member 30 thus has a function of smoothly passing the lining material and also a sealing function of preventing the liquid from leaking through the opening 31, and can also be referred to as a sealing member.

The number of opening members may be one, but an opening member 30′ having the same shape as the opening member 30 is, as shown in FIG. 7b, provided adjacent to the opening member 30 on the side of the eversion container 1 in order to improve the sealing property and prevent the lining material 60 from meandering. An opening 31′ of the opening member 30′ is the same size as the opening 31 and is aligned therewith. The opening members 30 and 30′ are provided with a plurality of bolt insertion holes 30b and 30b′, and a mount plate 32 for mounting the opening members 30 and 30′ is provided with the same number of bolt insertion holes 32a and a central opening 32b larger than the opening 31. The opening members 30 and 30′ are aligned and bolted so that the openings 31 and 31′ and the opening 32b of the mount plate 32 are aligned to pass the lining material.

Since the sealed portion 60c of the lining material 60, the connecting tool 62, and the hot water hose 63 are all smaller in thickness than h2, they can pass through the openings 31, 31′ of the opening members 30, 30′. Since the hot water hose 63 is further made of a flexible material and becomes flat, a hose having a diameter slightly larger than h2 can also be used.

The mount plate 32 of the opening section 2 is bolted to the flange 33a of a rectangular conduit 33 extending into the eversion container 1, and the lining material 60 passes through the opening members 30 and 30′ and the conduit 33 and guided into the eversion container 1.

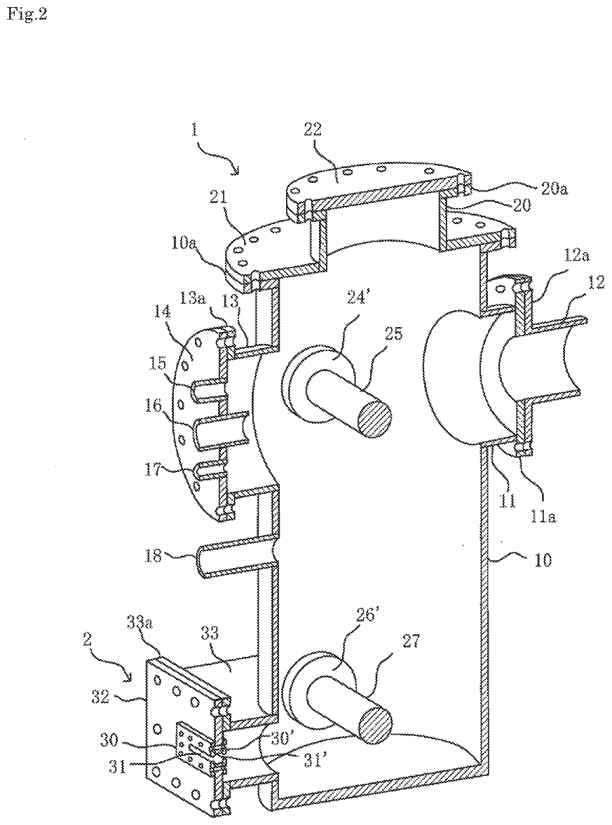

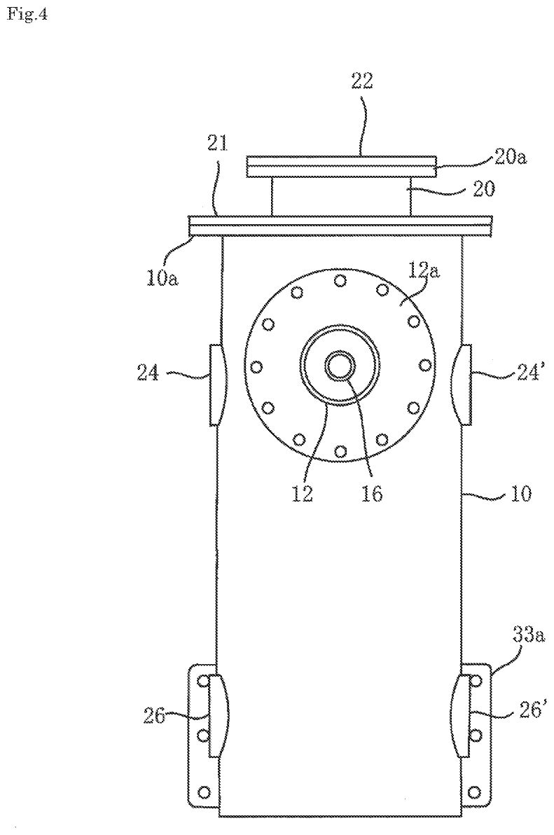

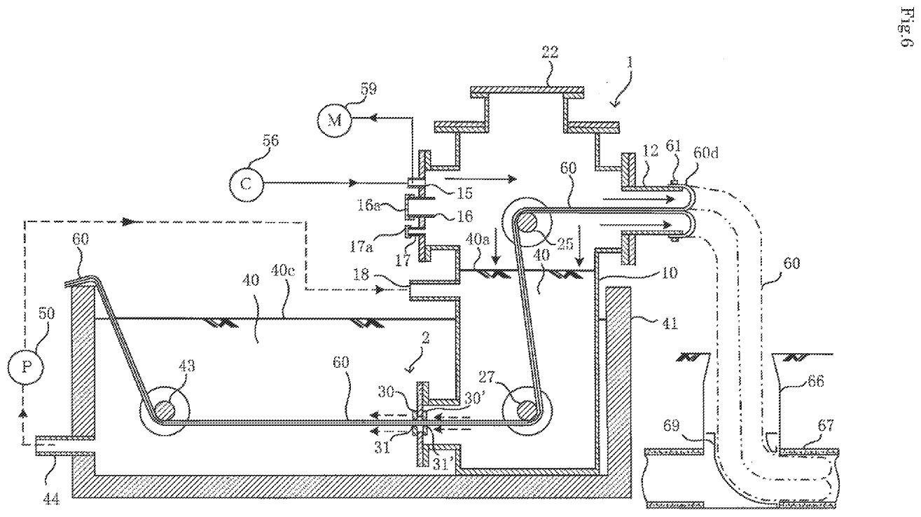

The eversion container 1 is, as shown in FIGS. 2 and 4, provided at its inside with a guide roller 25 that is supported by bearings 24 and 24′ and rotates freely, and is provided at the lower portion with a guide roller that is supported by hearings 26 and 26′ and rotates freely. The lining material 60 passing through the openings 31 and 31′ is guided by the guide rollers 27 and 25 and airtightly attached to the eversion nozzle 12 with a band 61 with its one end 60d folded back (FIG. 6).

As shown in FIG. 1, the eversion container 1 is disposed in a vertically standing state in a liquid tank 41 in which an incompressible liquid 40, for example, water or a hydraulic oil used for a hydraulic device, is stored. The liquid tank 41 is provided with a guide roller 43 supported by bearings 42 and 42′. The lining material 60 is introduced into the liquid tank 41 and then guided by the guide roller 43 in the direction toward the opening section 2 of the eversion container 1. Furthermore, a liquid drain port 44 for draining the liquid 40 in the liquid tank to the outside is attached to the lower portion of the liquid tank 41.

A liquid supply device for supplying the liquid 40 into the eversion container 1, for example, a liquid supply pump 50 is disposed outside the liquid tank 41. In a case where the liquid is water, a commercially available water supply pump is used as the liquid supply pump 50. The drain port of the liquid supply pump 50 is connected to the liquid supply port 18 of the eversion container 1 through a pipe 51 and a joint 52, and the suction port thereof is connected to the liquid drain port 44 of the liquid tank 41 through a pipe 53 and a joint 54. By driving a motor 55, the liquid supply pump 50 pumps the liquid 40 in the liquid tank 41 through the liquid drain port 44 and the pipe 53 and supplies the liquid from the drain port through the pipe 51 and the liquid supply port 18 to the eversion container 1.

A compressed gas source for supplying compressed gas, for example, compressed air, compressed carbon dioxide gas, or the like is disposed in the vicinity of the liquid tank 41. In this embodiment, an example in which compressed air is used as the compressed gas will be described, so that an air compressor 56 is used as the compressed gas source. The air compressor 56 supplies compressed air to the upper part of the liquid 40 in the eversion container 1 through a pipe 57, a joint 58, and a gas supply port 15. A barometer 59 is attached to the upper part of the gas supply port 15 to measure the atmospheric pressure of the supplied compressed air. Instead of compressing the gas with a compressor, the compressed gas can be supplied from a tank, a cylinder, etc. that stores the compressed gas. Therefore, the compressed gas source can also include a tank, a cylinder, etc. that stores the compressed gas.

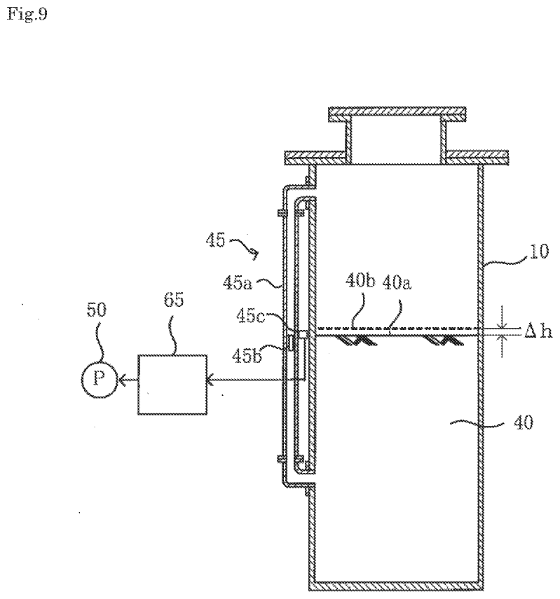

A liquid level gauge 45 for measuring the level of the liquid 40 in the eversion container 1 is attached to the eversion container 1. FIG. 9 shows a liquid level gauge 45 in the shape of a pipe 45a made of, for example, a transparent acrylic resin. The pipe 45a is airtightly attached at one end to the upper part of the eversion container 1 and at the other end to the lower part thereof so as to communicate with the inside of the eversion container 1. A float 45b to which a magnet is attached is provided in the pipe 45a, and a magnetic sensor 45c is attached to the outside of the pipe 45a.

The eversion container 1 is filled with the liquid 40 up to a predetermined level 40a beyond the openings 31, 31′. When the lining is started, compressed air is supplied to the upper part of the liquid 40 in the eversion container 1, and the air pressure due to the compressed air acts on the liquid 40 to cause the liquid 40 to flow out of the eversion container 1 to the liquid tank 41 through a gap between the opening of the opening section 2 and the lining material 60. When the liquid 40 falls below the level 40a due to this outflow, the magnetic sensor 45c detects the decrease to drive a motor 55 via a drive circuit 65 until the liquid reaches the level 40b, which is Δh higher than the level 40a. Every time the liquid falls below the level 40a, the motor 55 is driven to keep the liquid in the eversion container 1 substantially at the level 40a, allowing the eversion container 1 to be filled with the liquid 40 at the level 40a. The liquid level can also be adjusted by controlling a flow rate adjusting valve in the liquid supply pump 50. The liquid level gauge may include an electrode type liquid level gauge in which current flows between the around electrode and the detection electrode to detect the liquid level when it contacts the liquid.

Instead of thus automatically turning on and off the motor 55 of the liquid supply pump 50 according to the level of the liquid, an operator may monitor the level with the liquid level gauge 45 and drive the motor 55 for a predetermined time to maintain the liquid at the level 40a when the liquid drops below the level 40a. Alternatively, the amount of liquid outflow (leakage amount) may be estimated to adjust the flow rate adjustment valve of the liquid supply pump 50 and continuously operate it so as to compensate the outflow amount in order to maintain the liquid substantially at the level 40a.

The liquid tank 41 has a structure capable of storing the liquid 40 at a level 40c the same as or lower than the level 40a in the liquid tank 41 when the liquid 40 in the eversion container 1 is maintained at the level 40a.

Next, the operation of the thus configured apparatus for everting the lining material will be described. The eversion container 1, the liquid tank 41, the liquid supply pump 50, the air compressor 56, etc. are mounted in a state as shown in FIG. 1 on the loading platform of a work truck (not shown) and transported to a site. The work truck is moved to a position at which the eversion nozzle 12 lies on a manhole continuous with an existing pipe to be lined.

The mount plate 32 and the cover 21 (or the disk 22) of the opening section 2 are removed, and the disk 14 and the eversion nozzle 12 are removed as necessary. As shown in FIG. 6, the lining material 60 is guided through the guide rollers 43, 27 and 25 to the eversion nozzle 12 with one end 60d thereof folded back and airtightly attached thereto with the band 61. The removed members are bolted into an airtight state as before.

In the present invention, the lining material 60 can be continuously everted and inserted into the existing pipe without being limited to its length. Therefore, the lining material is rolled up or folded by a required length for storage in a housing container, and the housing container is mounted on a work truck. If the housing container cannot be mounted on the work truck on which the eversion container 1 or the like is mounted, it is mounted on another work truck.

Subsequently, the liquid 40 is supplied into the liquid tank 41, and the liquid supply pump 50 is driven to supply the liquid 40 to the eversion container 1 up to a level beyond the openings 31, 31′ of the opening members 30, 30′. The liquid supply into the eversion container 1 is performed by driving the liquid supply pump 50 or, in addition, removing the disk 22 to supply the liquid 40 from above into the eversion container 1. The liquid 40 becomes lower in level than the openings 31, 31′ in a short time due to an unexpected leakage thereof and the compressed air leaks from the openings 31, 31′. In order to prevent this, it is preferable to supply the liquid 40 up to a level sufficiently exceeding the openings 31 and 31′. If the liquid 40 is supplied to a very high level, the liquid 40 may flow into the eversion nozzle 12. Therefore, as shown in FIG. 6, the liquid 40 is supplied to the eversion container 1, for example, up to the predetermined level 40a which sufficiently exceeds the height of the openings 31, 31′ and at which the liquid does not flow into the eversion nozzle 12.

Since the hot water supply port 16 and the hot water drain port 17 in the eversion container 1 are not used when everting the lining material, they are airtightly sealed with caps 16a and 17a so as not to leak air (FIG. 6). The sections to be bolted in the eversion container 1 are airtight, and after the lining material 60 is airtightly attached to the eversion nozzle 12, the inside of the eversion container 1 is separated into a gas space and a liquid space to form an airtightly sealed space above the liquid 40.

In this state, the air compressor 56 is driven to supply compressed air to the airtightly sealed space in the eversion container 1. As shown by the solid line arrow in FIG. 6, the compressed air acts on the eversion nozzle 12 as an eversion pressure, so that the lining material 60 attached to the eversion nozzle 12 is everted and carried outside the eversion container 1 as shown by the virtual line, and it is guided to a bent pipe 69 through a manhole 66 for insertion into an existing pipe 67 such as a sewage pipe.

In a case in which the lining material having, for example, an outer diameter of 200 mm is everted, the lining material 60 has a width w2 of about 265 mm and a height (thickness) h2 of about 10 mm when it is, as shown in FIG. 8b, flattened. The lining material 60 thus configured is everted by applying the compressed air thereto. In this case, the width w1 and the height h1 of the slit-shaped openings 31, 31′ of the opening section 2 are set to be the same as or slightly larger than the width w2 and the height h2 of the flattened lining material so that it can pass therethrough. For example, in case the compressed air pressure is about 0.7 Mpa, the lining material 60 is everted from the eversion container 1 at a speed of about 3 m/min and inserted into the existing pipe 67. The compressed air pressure can be set to a desired atmospheric pressure by controlling the flow rate adjusting valve of the air compressor 56.

Since a slight gap is generated between the lining material 60 and the opening of the opening section 2, the compressed air acts on the liquid 40 to cause the liquid 40 to flow out of the eversion container 1 and fall below the level 40a. Every time the liquid level falls below the level 40a, the liquid supply pump 50 is driven for a predetermined time to suck out the liquid 40 in the liquid tank 41 and supplement it to the eversion container 1, as shown by the dotted arrow. This allows the liquid in the eversion container 1 to be maintained substantially at the level 40a. Therefore, the compressed air can be continuously used for everting the lining material, and the lining material can be continuously everted without limitation of the length thereof. Furthermore, only the liquid 40 leaks from the opening, allowing the noise caused by the fluid leakage at the time of eversion to be remarkably reduced. The lubricity of the liquid or the curved portions 32a, 32a′ of the openings 31, 31′ further allows the frictional resistance to be reduced when the lining material 60 passes through the openings 31, 31′. The lining material 60 receives buoyancy in the liquid tank 41, making smooth transfer possible without being bent by gravity.

The eversion efficiency of the lining material 60 depends on the smoothness of the lining material 60 as it passes through the opening of the opening section 2 and the sealing function of preventing the liquid 40 from flowing out of the gap between the lining material 60 and the opening. The smoothness of the opening section 2 and the sealing function conflict with each other. If the opening is, for example, enlarged for improvement in smoothness, the smoothness increases, but the gap also increases and the sealing function reduces. On the other hand, if the opening is made smaller, the sealing function improves but the smoothness disappears.

In this embodiment, MC nylon having good slippage or a metal polished to have good slipperiness (for example, stainless steel) is used as a material for the opening members 30 and 30′ for improvement in smoothness. The openings 31 and 31′ are further provided with the curved portions 30a and 30a′ to reduce the frictional resistance of the lining material 60 when passing through the openings.

On the other hand, not only the opening member 30 but also the opening member 30′ is provided to double and enhance the sealing function. A thickener such as CMC (carboxymethyl cellulose) or xanthan gum may be added to the liquid 40 to increase the viscous resistance when the liquid passes through the gap. If the sealing function is doubled, the smooth less disappears. Therefore, only the opening member 30 is used in a case where the smoothness is important.

When the sealed portion 60c of the lining material 60 passes through the openings 31, 31′ and the following hot water hose 63 passes therethrough, liquid leakage increases. For this, the liquid supply pump 50 is powered up to increases the supply amount from the liquid supply pump 50 in order to maintain the liquid level. If the liquid level cannot be maintained even if the liquid supply pump 50 is powered up, an opening section having an opening suitable for the passage of the hot water hose may be provided, as will be described later.

The higher the air pressure of the compressed air, the higher the eversion speed, which is preferable for everting the lining material 60. However, the larger the degree of compression, the larger the amount of the liquid 40 leaking from the gaps of the openings 31 and 31′. Therefore, the liquid level is measured by the liquid level gauge 45, and for a large amount of leakage, the amount of supply by the liquid supply pump 50 is increased to maintain the liquid level. If the liquid level cannot be maintained due to insufficient power of the liquid supply pump 50, the degree of compression of the air compressor 56 is adjusted.

The eversion operation is finished when the lining material 60 is everted over the entire length and inserted into the existing pipe to be lined over the entire area thereof and the tip of the hot water hose 63 connected to the end of the lining material 60 protrudes from the tip of the existing pipe.

Once the eversion work has been completed, the liquid 40 in the eversion container 1 is drained and the opening section 2 is airtightly closed by a cover (not shown). The end of the hot water hose 63 is guided to the hot water supply port 16 and hot water is supplied from a hot water source into the hot water hose 63. At this time, an appropriate amount of compressed air is supplied from the air compressor 56 into the eversion container 1 to expand the everted lining material 60 and press it against the inner wall surface of the existing pipe. The hot water is ejected from the hot water hose 63 onto the lining material 60 to cure the lining material 60, thus completing the lining work.

In a case where the hot water hose is not connected to the lining material and the lining material is cured without using the hot water hose, the hot water is directly supplied into the eversion container 1 from the hot water supply port 16 and the inside of the everted lining material 60 is fully filled with the hot water to cure the lining material.

The sealed portion 60c, the connecting tool 62, and the hot water hose 63 of the lining material 60 described above are all shaped so as to be able to pass through the openings 31, 31′ of the opening members 30, 30′. However, there are lining materials having a thickness (height) at which the sealed portions 60c and/or the connecting tool 62 cannot pass through the openings 31, 31′. For a water hose small in diameter, a large amount of liquid leaks from the openings 31 and 31′ when the hot water hose passes therethrough, and the power of the liquid supply pump 50 may not be able to compensate for the leak.

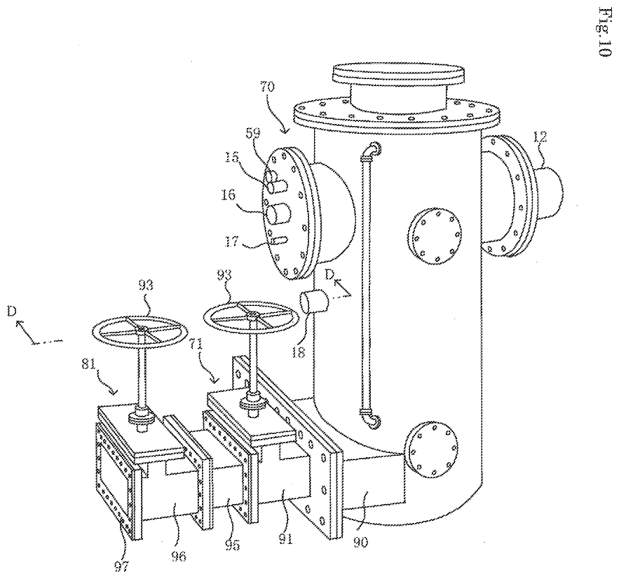

FIGS. 10 through 19 show eversion container 70 that solves the above-mentioned problems at the time when the end portion of the lining material or the hose connected thereto passes through the opening. Since the eversion container 70 is the same as the eversion container 1 except for its opening portions, the same parts are designated by the same reference numerals, and detailed description thereof will be omitted.

The eversion container 70 has at its lower portion a first opening section 71 provided with a variable opening through which a lining material passes and a second opening section 81 provided with a variable opening through which a hot water hose connected to the end of the lining material passes.

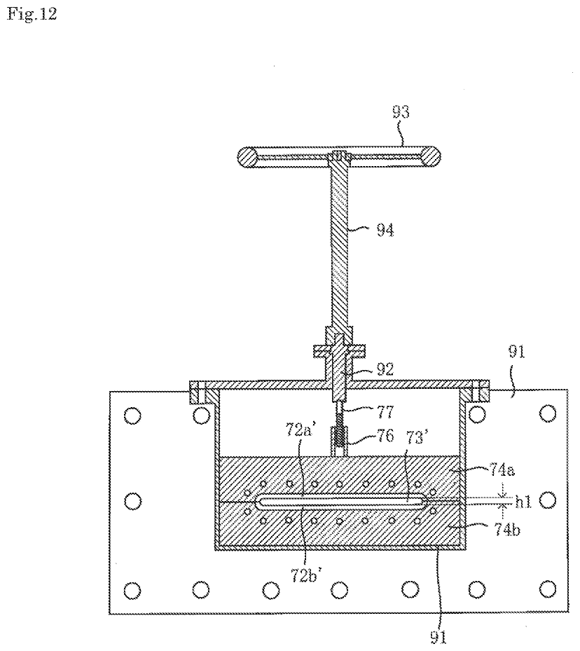

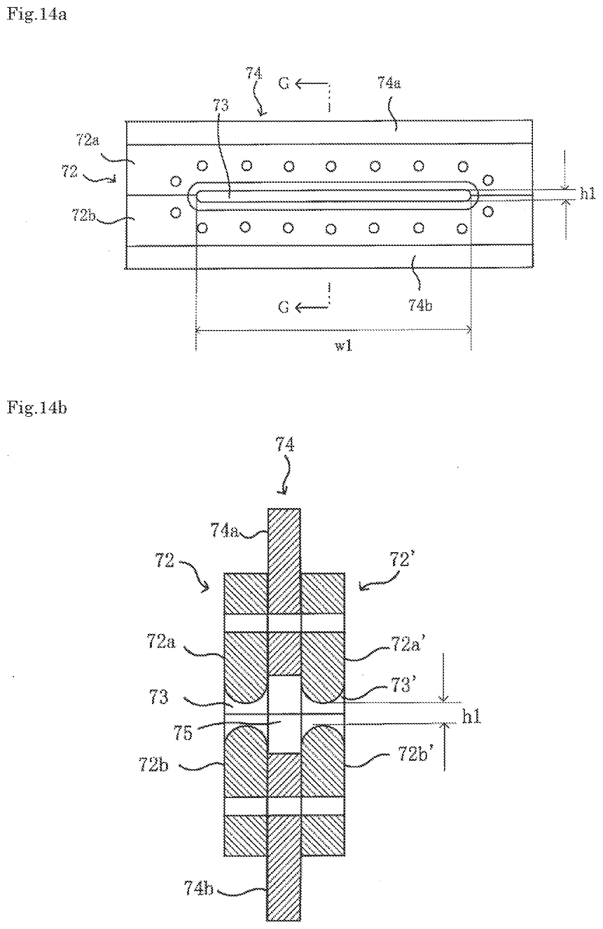

FIGS. 12, 13, 14a and 14b show the detailed configuration of the first opening section 71. The first opening section 71 has an opening member 72 made of the same material and having the same shape as the opening member 30 of the opening section 2. While the opening member 30 is an integral member, the opening member 72 is vertically symmetrically divided into two halves 72a and 72b as shown in FIGS. 14a and 14b. Like the opening member 30, the opening member 72 has a horizontally extending slit-shaped opening 73 having a width w1 and a height h1 corresponding to the cross-sectional shape of the flattened lining material 60. Similar to the opening 31, the opening 73 is curved in an arc shape at the vertical upper and lower ends so that the lining material 60 passes through the opening 73 in line contact with the upper and lower ends thereof.

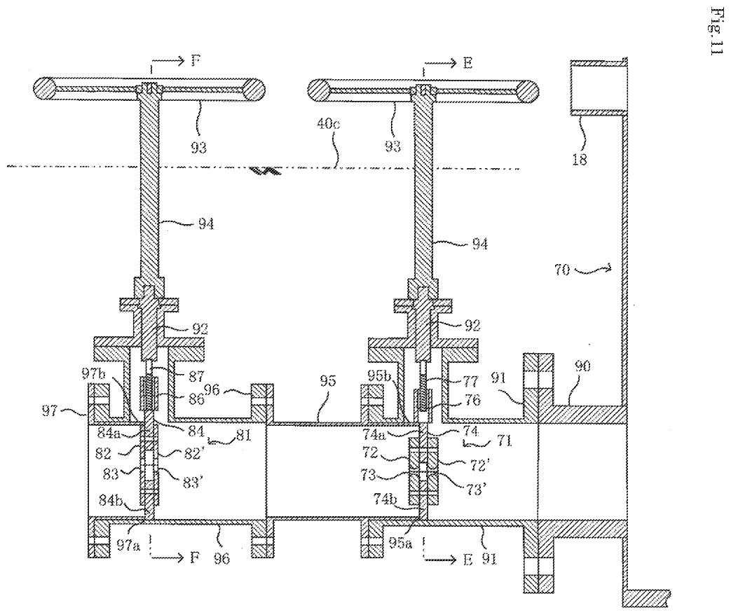

The opening member 72 may be one, but, as shown in FIG. 11, an opening member 72′ provided with an opening 73′ and having the same shape as the opening member 72 is provided adjacent to the opening member 72 on the side of the eversion container 1 in order to improve the sealing property. The openings 73 and 73′ have the same shape, and the opening members 72 and 72′ are aligned so that the openings 73 and 73′ are aligned. Similar to the opening member 72, the opening member 72′ is, as shown in FIG. 14b, vertically symmetrically divided into two halves 72a′ and 72b′. A mount plate 74 which is provided with an opening 75 and serves to mount the opening members 72 and 72′ is also vertically symmetrically divided into two halves 74a and 74b. The upper halves 72a, 72a′ of the opening members 72, 72′ are attached to the upper half 74a of the mount plate 74, and the lower halves 72b, 72b′ thereof are attached to the lower half 74b of the mount plate 74.

The first opening section 71 is disposed in a conduit 91 following a conduit 90 connected to the eversion container 70 with a nut 76 and a bolt 77 disposed on the upper portion thereof (FIG. 11). The lower end of the nut 76 is fixed to the half 74a of the mount plate 74 and the bolt 77 is connected to a rod 94 of a handle 93 using a connector 92. With such a configuration, the handle 93 is rotated to rotate the bolt 77 and vary the degree of its penetration into the nut 76. This causes the half 74a of the mount plate 74 and the halves 72a and 72a′ of the opening members 72, 72′ attached to the half 74a thereof (hereinafter referred to as the upper portion of the first opening section 71) to move up and down in the vertical direction according to the rotation of the handle 93.

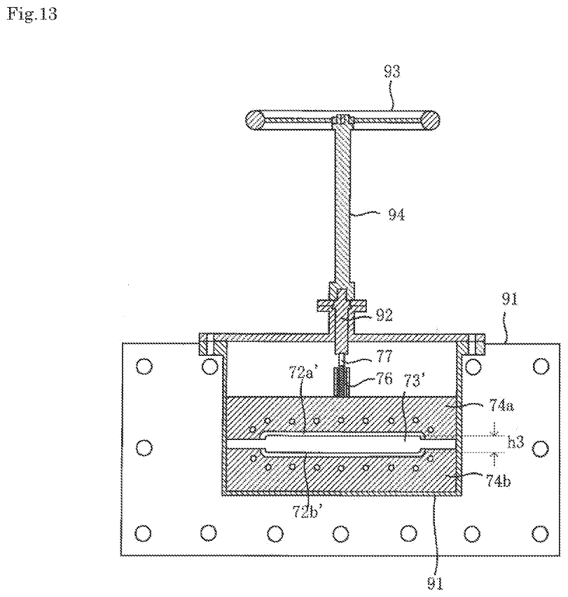

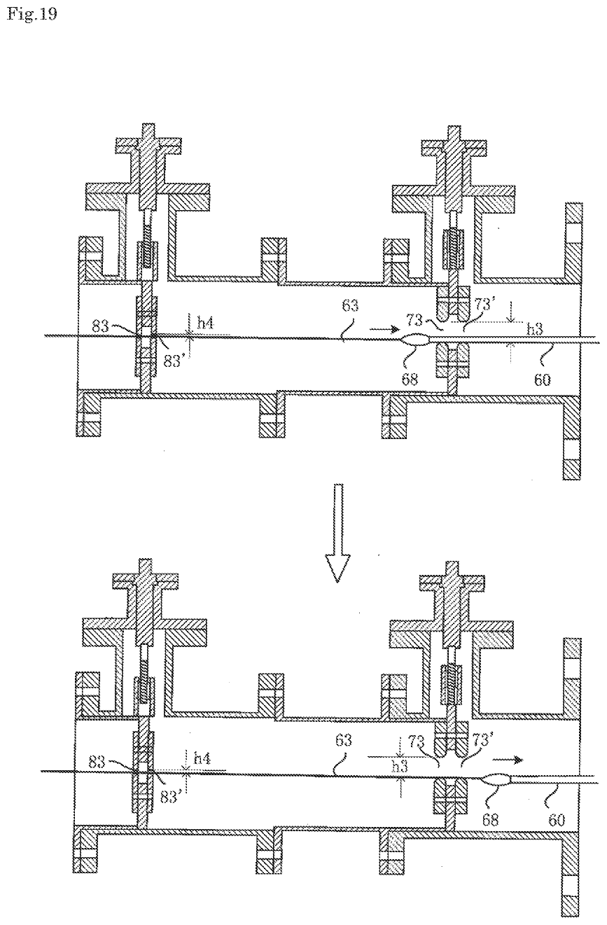

The lower half 74b of the mount plate 74 is fixed to a bottom 95a of a connecting pipe 95 inserted into the conduit 91, or is seated on the bottom of the conduit 91 by its own weight and held by a guide plate, so that, when the handle 93 is rotated to raise the nut 76, the upper portion of the first opening section 71 ascends from the position shown in FIGS. 11 and 12 to the position shown in FIG. 13. This ascending is performed until the half 72a of the opening member 72 abuts on the upper end 95b of the connecting pipe 95, and as shown in FIG. 13, the openings 73, 73′ of the opening members 72, 72′ have a vertical length enlarged to h3. As shown in FIG. 19, the vertical length h3 of the openings 73 and 73′ are larger than the vertical length of a connecting tool 68 connecting the lining material 60 and the hot water hose 63, and is so large as the connecting tool 68 can pass through the openings 73, 73′ without any trouble. Although not shown, a guide plate for smoothly moving the upper portion of the first opening section 71 in the vertical direction is disposed in the conduit 91.

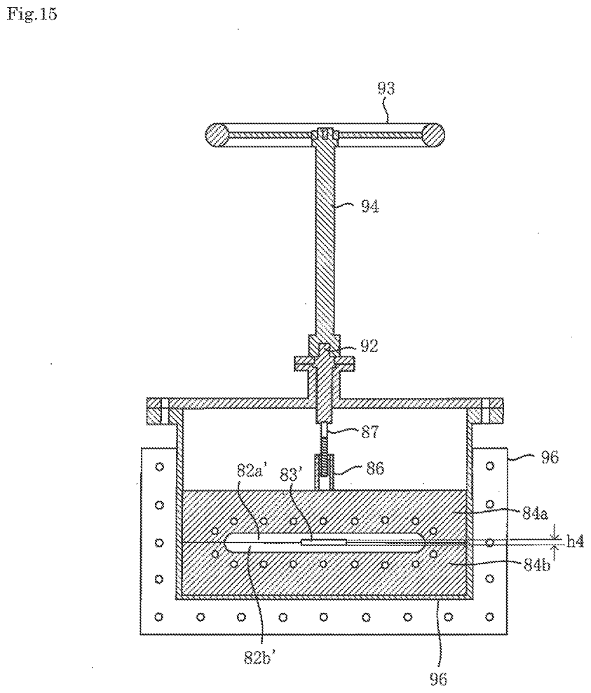

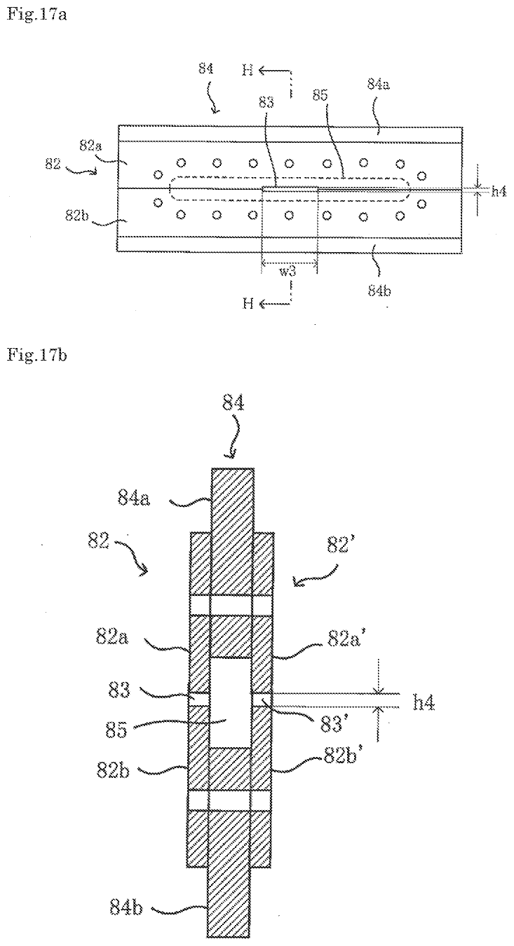

FIGS. 15, 16, 17a and 17b show the detailed configuration of the second opening section 81. Like the first opening section 71, the second opening section 81 has an opening member 82 that is vertically symmetrically divided into two halves 82a and 82b and provided with a horizontally extending slit-shaped opening 83 having a width w3 and a height The opening 83 is sized to come into contact with the hot water hose 63 and pass it therethrough. The opening member 82 may be one, but, as shown in FIG. 17b, an opening member 82′ provided with an opening 83′ and having the same shape as the opening member 82 is provided adjacent to the opening member 82 in order to improve the sealing property. The openings 83 and 83′ have the same shape, and the opening members 82 and 82′ are aligned so that the openings 83 and 83′ are aligned. Similar to the opening member 82, the opening member 82′ is vertically symmetrically divided into two halves 82a′ and 82b′. The upper halves 82a, 82a′ of the opening members 82, 82′ are attached to an upper half 84a of a mount plate 84 that is provided with an opening 85 and similarly divided into two. The lower halves 82b and 82b′ of the opening members 82, 82′ are attached to the lower half 84b of the mount plate 84.

The second opening section 81 is disposed in a conduit 96 following the connecting pipe 95, and a nut 86 fixed to the half 84a of the mount plate 84 and a bolt 87 are disposed on the upper portion of the second opening section 81 (FIG. 11). The bolt 87 is connected to the rod 94 of the handle 93 using the connector 92. Like the first opening section 71, the handle 93 is rotated to move up and down the half 84a of the mount plate 84 and the halves 82a and 82a′ of the opening members 82, 82′ fixed thereto (hereinafter referred to as the upper portion of the second opening section 81) in the vertical direction according to the rotation of the handle 93.

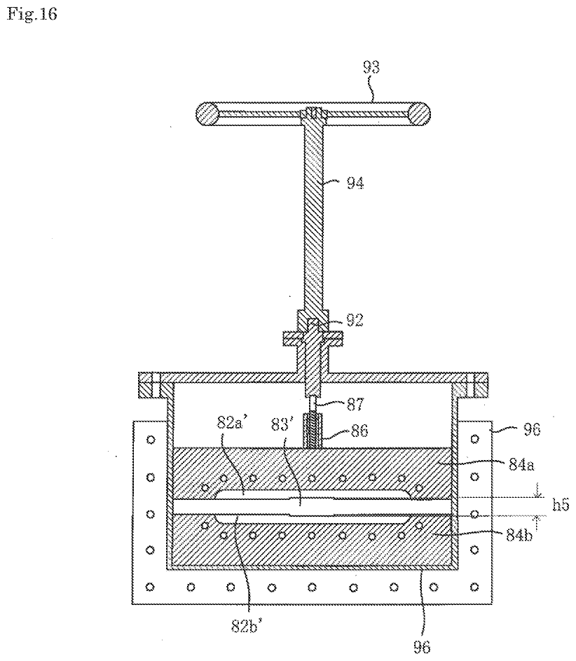

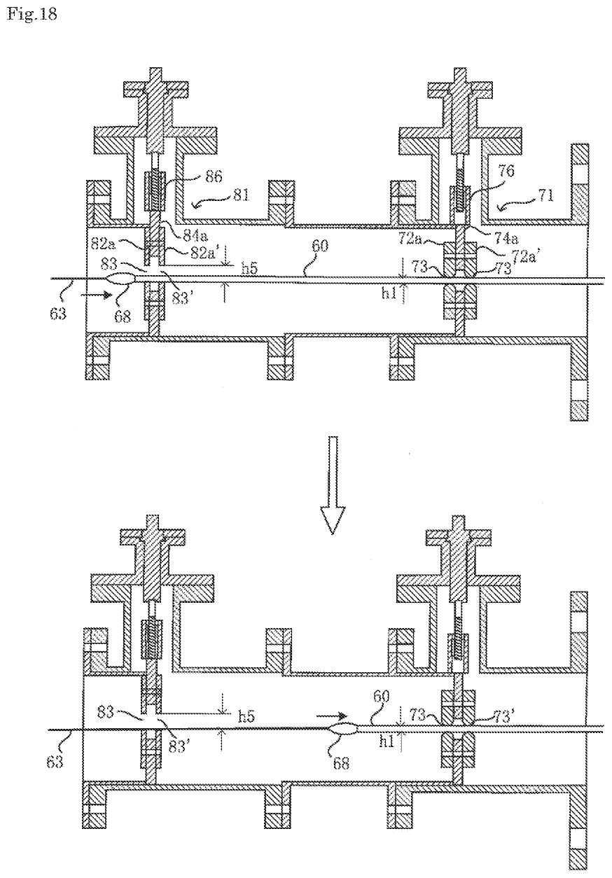

The lower half 84b of the mount plate 84 is fixed to a bottom 97a of a conduit 97 inserted into the conduit 96, or is seated on the bottom of the conduit 96 by its own weight and held by a guide plate, so that, when the handle 93 is rotated to raise the nut 86, the upper portion of the second opening section 81 ascends from the position shown in FIGS. 11 and 15 to the position shown in FIG. 16. This ascending is performed until the half 82a of the opening member 82 abuts on the upper end 97b of the conduit 97, and as shown in FIG. 16, the openings 83, 83′ of the opening members 82, 82′ have a vertical length enlarged to h5. As shown in FIG. 18, the vertical length h5 of the openings 83 and 83′ are larger than the vertical length of the lining material 60, the hot water hose 63, and the connecting tool 68 connecting them. Although not shown, a guide plate for smoothly moving the upper portion of the second opening section 81 in the vertical direction is disposed in the conduit 96.

FIGS. 18 and 19 are illustrative views showing changes in the openings when the end portion of the lining material 60 and the hot water hose 63 pass through the first and second opening sections 71 and 81. When the lining material 60 passes through the first and second opening sections 71 and 81, the upper portion of the first opening section 71 descends to provide the openings 73 and 73′ of h1 as shown in the upper part of FIG. 18, and the upper portion of the second opening section 81 ascends to provide the openings 83, 83′ of h5. In this state, the connecting tool 68 can pass through de openings 83 and 83′ of the second opening section 81, so that the lining material 60 is being everted without any trouble.

On the other hand, the connecting tool 68 cannot pass through the opening 73. Therefore, by the time the connecting tool 68 reaches the position shown in the upper part of FIG. 19 from the position shown in the lower part of FIG. 18, the operator operates the handle 93 to cause the upper portion of the first opening section 71 to be raised to enlarge the openings 73 and 73′ to h3, and cause the upper portion of the second opening 81 to be lowered to reduce the openings 83 and 83′ to h4. The timing of this handle operation is determined based on the eversion speed of the lining material 60 and the distance between the first and second opening sections 71 and 81. As shown in FIG. 11, the handle 93 is located above the liquid level 40c in the liquid tank 41, so that the operator can operate the handle 93 without difficulty.

As shown in the lower part of FIG. 19, the operator continues everting the lining material 60 without changing the size of the openings 73, 73′ and the openings 83, 83 after the connecting tool 68 passes through the openings 73, 73′ of the first opening section 71. The eversion work is completed when the tip of the hot water hose 63 protrudes from the tip of the existing pipe. As shown in FIG. 17a, the openings 83 and 83′ are small slit-shaped openings having a width w3 and a height h4, and the hot water hose 63 is made of a material so flexible that it can be flattened and pass through the openings. This allows a gap between the openings 83, 83′ and the hot water hose 63 to be very small. Therefore, the amount of liquid leaking from this gap is small, and the eversion operation can be carried out while maintaining the liquid level in the eversion container 70 without increasing the power of the liquid supply pump 50.

The two opening sections are thus provided and the openings thereof are made variable. This allows the lining material to be reliably everted even in a case where the diameter of the lining material or the end portion (sealed portion and/or connecting tool) of the lining material is different in size.

### Embodiment 2

In Embodiment 1 described above, the lining material can be everted and inserted into the existing pipe without limiting the length of the lining material. However, in a case in which the total length of the lining material to be inserted into the existing pipe becomes long, the frictional resistance of the lining material with the existing pipe increases and the amount of air required for eversion increases. This makes the eversion difficult due to insufficient capacity with a small air compressor. On the other hand, the eversion is likely to be out of control if a large air compressor is used as a countermeasure.

In Embodiment 2, in addition to the eversion pressure due to compressed air, the circulating liquid 40 in the liquid tank 41 is injected into the lining material 60 in an attempt to also utilize the eversion pressure due to the hydraulic pressure of the liquid 40 to evert the lining material.

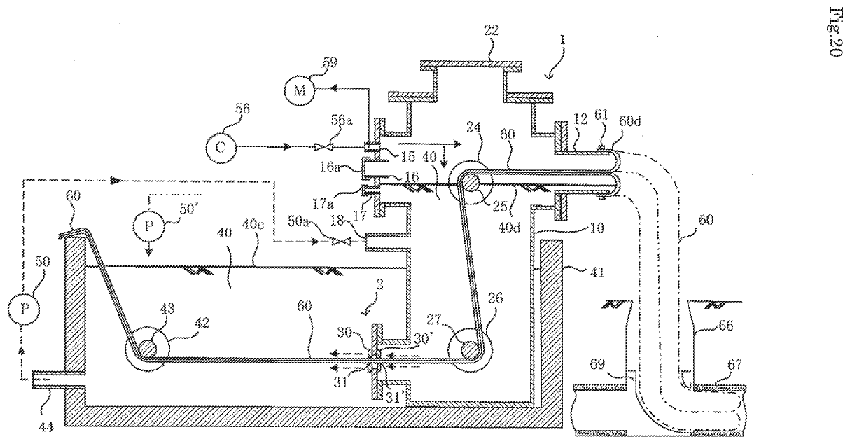

As shown in FIG. 20, the liquid level in the eversion container 1 is controlled to a level 40d higher than that of the eversion nozzle 12, and the liquid 40 is caused to overflow from the eversion nozzle 12 for supply into the lining material 60. In the sealed eversion container 1, increasing the liquid allows the lining material to be everted due to the hydraulic pressure even if the air compressor 56 is stopped. At the time of hydraulic eversion, the liquid 40 is consumed from the liquid tank 41 by an amount of liquid that is supplied in the lining material 60. Therefore, a liquid supply pump 50′ is, as shown by a virtual line in FIG. 20, used to replenish the liquid 40 from a tank car (not shown) that stores the liquid in order to constantly store the liquid exceeding the openings 31 and 31′ in the liquid tank 41. Provided are further a flow rate adjusting valve 50a for adjusting the amount of liquid supplied from the liquid supply pump 50 and a flow rate adjusting valve 56a for adjusting the flow rate of compressed air from the air compressor 56.

Since the hydraulic eversion is slower than the pneumatic eversion, the latter is used at first. The lining material 60 is guided to the eversion nozzle 12 and attached at one end to the eversion nozzle 12. After that, the liquid supply pump 50 is driven with the flow rate adjusting valve 50a fully opened to supply the liquid 40 into the liquid tank 41 so that the liquid level in the eversion container 1 is lower than the level of the eversion nozzle 12. In this state, the flow rate adjusting valve 56a is fully opened to drive the air compressor 56. Since the compressed air acts as an eversion pressure on the lining material 60 attached to the eversion nozzle 12, the lining material 60 is inserted into the existing pipe 67 through the manhole 66 and the bent pipe 69.

After the lining material 60 is inserted due to the air pressure for a predetermined length, for example, several meters from the inlet of the existing pipe 67, the flow rate adjusting valve 56a is temporarily closed to interrupt the pneumatic eversion. While fully opening the flow rate adjusting valve 50a, the liquid 40 is, as shown in FIG. 20, caused to overflow from the eversion nozzle 12 to start the hydraulic eversion. Subsequently, the flow rate adjusting valve 56a is opened to restart the pneumatic eversion. The amount of liquid supplied for hydraulic eversion, that is, the amount of overflow of the liquid 40 is adjusted by the flow rate adjusting valve 50a, so that the liquid level control shown in FIG. 9 is stopped.

The eversion speed of the lining material 60 due to air pressure can be controlled by adjusting the amount of air supply with the flow rate adjusting valve 56a. When the amount of water supplied into the lining material 60 increases and the liquid level in the lining material rises, the flow rate adjusting valve 50a reduces the amount of water supplied in a case where the eversion speed increases and the liquid level in the lining material pipe decreases, the flow rate adjusting valve 50a increases the amount of water supplied.

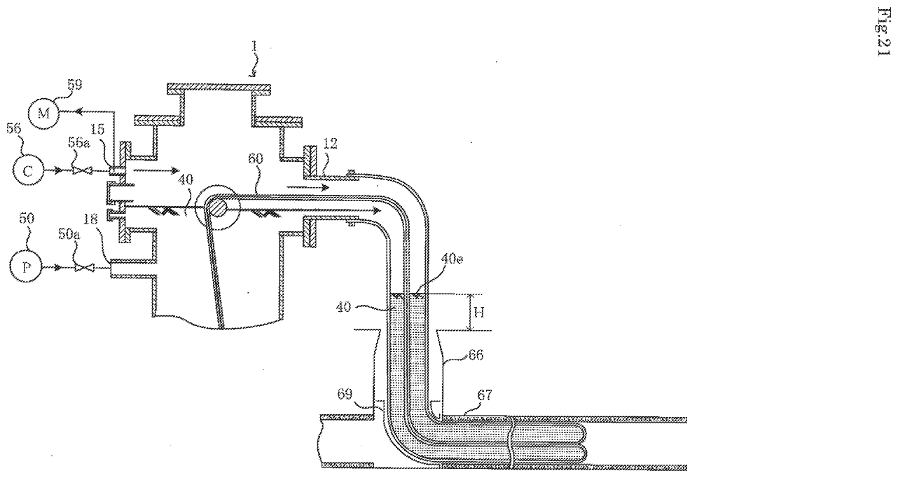

By adjusting the opening degree of the flow rate adjusting valve 56a to adjust the eversion speed due to the air pressure and adjusting the opening degree of the flow rate adjusting valve 50a to adjust the amount of liquid supplied into the lining material 60, the pneumatic eversion and the hydraulic eversion are performed so that the liquid level 40e in the lining material 60 is, as shown in FIG. 21, at a predetermined height H (for example, H=0 to 2 m) that lies beyond the ground up to the lower end of the eversion nozzle 12. The liquid level 40e in the lining material can be roughly grasped by visual inspection, tentacles, or tapping sound of the lining material 60 on the ground.

As is clear from FIG. 21, performing the hydraulic eversion in addition to the pneumatic eversion causes the sealed space required for pneumatic eversion to be reduced, and allows the lining material to be effectively everted with a small air compressor even if a lining material has a long overall length. Even in a case where the lining material having a long overall length is everted, the eversion is performed while supplying the liquid. This allows the in-pipe resistance of the lining material to be reduced. The flow rate adjusting valves 50a and 56a are further used to adjust the liquid supply amount and the eversion speed with ease, so that the eversion operation is simplified.

Once the lining material 60 has been everted over the entire length thereof and inserted over the entire area of the existing pipe to be lined, the eversion operation is stopped. The lining material 60 is already filled with the liquid 40, so that the liquid 40 is guided to a work truck (not shown) equipped with a boiler, and it is heated and circulated by the boiler to heat and cure the lining material 60. In this way, the heat curing work can be started at the same time as the eversion is completed. Therefore, it is advantageous that the time is shortened and there is no need to attach the heat curing hot water hose 63 as shown in FIG. 8 to the end of the lining material 60. In order to reach the amount of liquid poured in the lining material to the amount required for heat curing, it is preferable to adjust the amount of liquid supplied so that the liquid level 40e in the lining material reaches a level slightly above the upper end of the existing pipe 67 at the time the eversion nearly ends.

### Embodiment 3

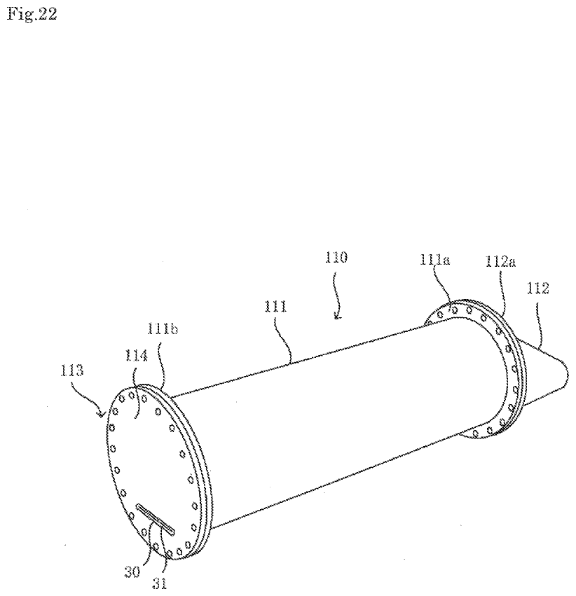

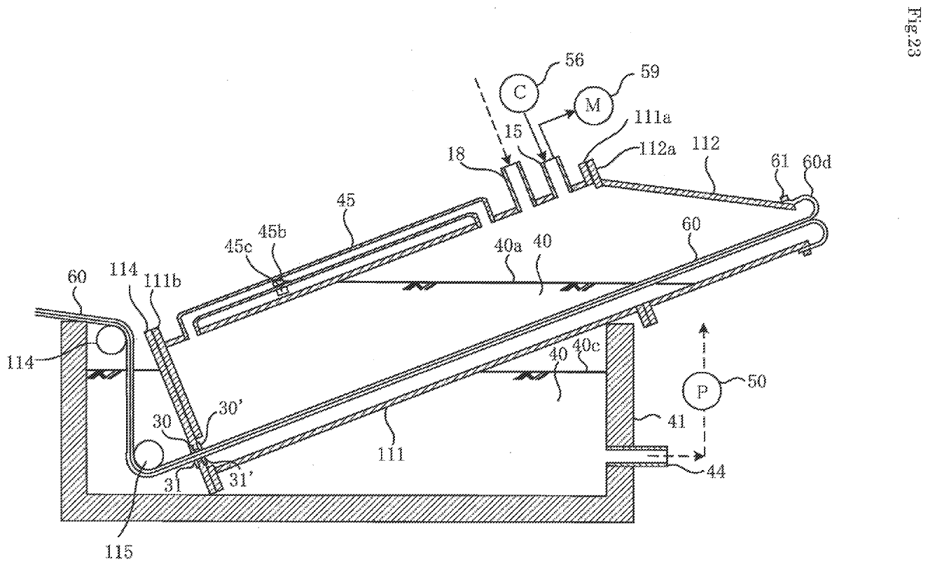

In Embodiments 1 and 2 described above, the eversion containers 1 and 70 are disposed upright in the liquid tank 41. FIGS. 22 and 23 show an embodiment in which the eversion container is disposed obliquely in the tank 41. The same parts as those in each embodiment are designated by the same reference numerals, and the details thereof will be omitted.

As shown in FIG. 22, an eversion container 110 includes a metallic cylindrical portion 111 configured as a pressure resistant tube and a conical eversion nozzle 112. The eversion nozzle 112 is attached to the cylindrical portion 111 by bolting a flange 112a thereof and a flange 111a of the cylindrical portion 111. The cylindrical portion 111 is provided at the bottom with a flange 111b to which a disk 114 with opening members 30 and 30′ is bolted. The opening members 30, 30′ and the disk 114 constitute an opening section 113.

FIG. 23 shows a state in which the eversion device shown in FIG. 22 is used to evert the lining material 60. The eversion container 110 is obliquely disposed in the liquid tank 41 in a laid state so that the lower portion of the cylindrical portion 111 touches the bottom portion of the liquid tank 41 and the upper portion touches the upper portion thereof.

The eversion nozzle 112 is removed from the cylindrical portion 111, and the lining material 60 is guided into the liquid tank 41 through guide rollers 114 and 115 and passed through the openings 31, 31′ of the opening members 30 and 30′. Subsequently, one end 60d of the lining material 60 is folded back and airtightly attached to the eversion nozzle 112 using the band 61. The eversion nozzle 112 is then bolted to the cylindrical portion 111.

Next, the liquid 40 is supplied to the liquid tank 41, and the liquid supply pump 50 is driven to supply the liquid 40 to the eversion container 110 until the liquid in the eversion container 110 reaches a predetermined level 40a exceeding the openings 31 and 31′.

Subsequently, the air compressor 56 is driven to supply compressed air to the airtightly sealed space above the liquid 40 in order to evert the lining material 60 for insertion into the existing pipe through the manhole.

When the compressed gas acts on the liquid 40 to cause the liquid 40 to flow out through a gap between the openings 31, 31′ and the lining material 60 and the liquid level to drop below the level 40a, the liquid supply pump 50 is driven to maintain the liquid level in the eversion container at the level 40a. In a case where the liquid level gauge 45 does not detect a level drop, the power of the liquid supply pump 50 is adjusted so that the outflow amount is returned to the eversion container 110. If the compression pressure is too high, the outflow amount of the liquid 40 also increases, so that the barometer 59 monitors the compression pressure to adjust the power of the air compressor 56.

When the hot water hose connected to the lining material 60 is inserted into the existing pipe, the eversion operation is completed. The eversion container 110 is filled with the liquid of the predetermined level 40a. Therefore, the compressed air can be used to continuously evert the lining material without leaking from the openings 31, 31′ of the opening 113, and the lining material can continue to be everted without limitation of the lining material length. In such a configuration, the lining material 60 is guided to the eversion nozzle 112 substantially linearly without contact without using a guide roller the eversion container 110, so that the lining material 60 moves smoothly.

For eversion of a lining material having a different diameter, an opening section is used that has a different opening depending on the diameter of the lining material. Specifically, the mount plate 32 or the disk 114 is removed together with the opening members 30 and 30′, and a mount pirate or a disk is used that mounts an opening member having an opening through which the lining material of the different diameter can pass.

In each of the above-described embodiments, the opening of the opening section is a slit-shaped opening having dimensions corresponding to the width and thickness of the flattened lining material, but the opening may be such that it allows the lining material to be inserted and passed therethrough with a small gap through which tine lining material passes, and the opening may be shaped so as to correspond to the cross-sectional shape of the passing lining material. For example, when the lining material is partially thickened and folded, an opening member is used that has an opening corresponding to the folded cross-sectional shape.

In each of the above-described embodiments, the eversion container is disposed inside the liquid tank, but it may be disposed outside the liquid tank. At this time, the liquid leaking from the opening is collected separately using a collection container. In this case, the liquid tank 41 stores a liquid exceeding the amount of liquid expected to leak from the opening by the time the eversion operation is completed, or the collected liquid may be returned to the eversion container by the liquid supply pump.

### KEY TO THE SYMBOLS

1 eversion container

2 opening section

10 cylindrical portion

12 eversion nozzle

15 gas supply port

16 hot water supply port

17 hot water drain port

18 liquid supply port

30, 30′ opening member

31, 31′ opening

40 liquid

41 liquid tank

44 liquid drain port

45 liquid level gauge

50 liquid supply pump

56 air compressor

59 barometer

60 lining material

63 hot water hose

66 manhole

67 existing pipe

68 connecting tool

70 eversion container

71 first opening

72, 72′ opening member

73, 73′ opening

74 mount plate

75 openings

81 second opening

82, 82′ opening member

83, 83′ opening

84 mount plate

85 opening

110 eversion container

112 eversion nozzle

113 opening

1. An apparatus in which a tubular lining material is airtightly attached at one end to an eversion nozzle and eversion pressure is applied to the eversion nozzle to evert the lining material, comprising:
an opening section having an opening through which the lining material can pass in contact therewith;
an eversion container having an eversion nozzle to which the one end of the lining material is airtightly attached, the container being filled with an incompressible liquid up to a predetermined level beyond the opening to form an airtightly sealed space above the liquid;
a compressed gas source that supplies compressed gas to the airtightly sealed space to evert and discharge the lining material attached to the eversion nozzle to the outside of the eversion container;
a liquid tank that stores the liquid with which the eversion container is filled; and
a liquid supply device that supplies the liquid to the eversion container in compensation for the liquid flowing out of the eversion container under the action of the compressed gas through a gap between the opening and the lining material so that the liquid in the eversion container is kept at the predetermined level.

2. An apparatus according to claim 1, wherein the eversion container is disposed in the liquid tank so that the liquid flowing out of the opening flows into the liquid tank, and the liquid supply device sucks the liquid in the liquid tank to supply the sucked liquid into the eversion container.

3. An apparatus according to claim 1, wherein a liquid level gauge is provided to measure the liquid level in the eversion container, and the liquid supply device is operated so that the liquid is kept at the predetermined level based on the measured level.

4. An apparatus according to claim 1, wherein the opening section is attached to the eversion container interchangeably with an opening section having a different opening depending on the diameter of the lining material to be everted.

5. An apparatus according to claim 1, wherein the opening of the opening section is a variable opening whose size is variable.

6. An apparatus according to claim 1, wherein the opening of the opening section is a slit-shaped opening corresponding to the cross-sectional shape of the lining material that is flattened.

7. An apparatus according to claim 6, wherein the opening of the opening section is curved in an arc shape in the direction of the lining material so that the end portion thereof in the thickness direction of the flattened lining material comes in line contact with the outer peripheral surface of the lining material.

8. An apparatus according to claim 1, wherein the opening section is provided adjacent to the opening thereof on the side of the eversion container with an opening that has the same shape as the opening and is disposed so as to be aligned therewith.

9. An apparatus according to claim 1, wherein the opening section is composed of a first opening section having an opening through which the lining material passes in contact therewith and a second opening section having an opening through which an accessory connected to the end of the lining material passes in contact therewith, the opening of the second opening section being enlarged so as to allow the passage of the lining material when it passes therethrough.

10. A method for everting a lining material using an apparatus according to claim 1, comprising:
guiding the lining material from the opening section to the eversion nozzle and airtightly attaching one end of the lining material to the eversion nozzle;
filling the eversion container with an incompressible liquid up to a predetermined level beyond the opening of the opening section to form an airtightly sealed space above the liquid;
supplying the compressed gas to the airtightly sealed space to evert and discharge the lining material attached to the eversion nozzle to the outside of the eversion container; and
supplying the liquid to the eversion container in compensation for the liquid flowing out of the eversion apparatus through the opening under the action of the compressed gas so that the liquid in the eversion container is kept at the predetermined level.

11. A method according to claim 10, wherein the predetermined level is a level at which the liquid does not flow into the eversion nozzle, and the eversion due to the compressed gas is performed.

12. A method according to claim 10, wherein the predetermined level is a level at which the liquid flows into the eversion nozzle, and the eversion due to the flowing liquid is performed in addition to the eversion due to the compressed gas.
